(19) United States
(12) Patent Application Publication
(10) Pub. No.: US 2014/0279268 A1
(43) Pub. Date: Sep. 18, 2014

(54) METHODS AND SYSTEMS FOR ALTERNATIVE TRIP COMPARISONS AND/OR QUEUE-BASED INTERACTIONS

(71) Applicant: Concur Technologies, Inc., Bellevue, WA (US)

(72) Inventors: Sylvain Ludovic MULLER, Bretigny sur Orge (FR); Philippe JEAN, Rosny sur Seine (FR); Gabriel DE ARAUJO, Paris (FR); Claire FIGUERAS, Bagneux (FR)

(73) Assignee: Concur Technologies, Inc., Bellevue, WA (US)

(21) Appl. No.: 14/213,550

(22) Filed: Mar. 14, 2014

Related U.S. Application Data
(63) Continuation-in-part of application No. 14/188,414, filed on Feb. 24, 2014.
Application No. 14/188,414 is a continuation of application No. 13/602,589, filed on Sep. 4, 2012, now Pat. No. 8,712,811.
Application No. 13/602,589 is a continuation-in-part of application No. 13/593,108, filed on Aug. 23, 2012.
Application No. 13/602,589 is a continuation-in-part of application No. 13/277,923, filed on Oct. 20, 2011, now Pat. No. 8,620,750.
Application No. 13/602,589 is a continuation-in-part of application No. 13/277,916, filed on Oct. 20, 2011.
Application No. 13/602,589 is a continuation-in-part of application No. 12/901,947, filed on Oct. 11, 2010.
Application No. 13/602,589 is a continuation-in-part of application No. 12/773,282, filed on May 4, 2010.
Application No. 13/602,589 is a continuation-in-part of application No. 11/763,562, filed on Jun. 15, 2007.
Application No. 11/763,562 is a continuation of application No. 10/270,672, filed on Oct. 16, 2002, now abandoned.
Application No. 13/602,589 is a continuation-in-part of application No. 13/396,255, filed on Feb. 14, 2012.
Application No. 13/396,255 is a continuation of application No. 12/755,127, filed on Apr. 6, 2010, now Pat. No. 8,140,361.
Application No. 12/755,127 is a continuation of application No. 10/373,096, filed on Feb. 26, 2003, now Pat. No. 7,720,702.
Application No. 13/602,589 is a continuation-in-part of application No. 13/117,303, filed on May 27, 2011.
Application No. 13/117,303 is a continuation of application No. 11/159,398, filed on Jun. 23, 2005, now Pat. No. 7,974,892.
Application No. 11/159,398 is a continuation-in-part of application No. 14/036,320, filed on Sep. 25, 2013.
Application No. 14/036,320 is a continuation-in-part of application No. 13/830,319, filed on Mar. 14, 2013.
Application No. 13/830,319 is a continuation of application No. 13/712,614, filed on Dec. 12, 2012.
Application No. 14/036,320 is a continuation-in-part of application No. 13/830,410, filed on Mar. 14, 2013.
Application No. 13/830,410 is a continuation of application No. 13/712,629, filed on Dec. 12, 2012.
Application No. 13/712,629 is a continuation-in-part of application No. 13/606,494, filed on Sep. 7, 2012.
Application No. 13/606,494 is a continuation-in-part of application No. 13/602,589, filed on Sep. 4, 2012, now Pat. No. 8,712,811.
Application No. 13/602,589 is a continuation-in-part of application No. 13/842,913, filed on Mar. 15, 2013.
Application No. 13/842,913 is a continuation-in-part of application No. 13/593,108, filed on Aug. 23, 2012.
Application No. 13/842,913 is a continuation-in-part of application No. 13/396,255, filed on Feb. 14, 2012.
Application No. 13/396,255 is a continuation-in-part of application No. 14/060,960, filed on Oct. 23, 2013.
Application No. 14/060,960 is a continuation of application No. 13/277,923, filed on Oct. 20, 2011, now Pat. No. 8,620,750.
(60) Provisional application No. 61/799,984, filed on Mar. 15, 2013.
(60) Provisional application No. 61/799,771, filed on Mar. 15, 2013.
(60) Provisional application No. 61/569,942, filed on Dec. 13, 2011.
(60) Provisional application No. 61/569,949, filed on Dec. 13, 2011.
(60) Provisional application No. 61/529,680, filed on Aug. 31, 2011.
(60) Provisional application No. 61/405,480, filed on Oct. 21, 2010.
(60) Provisional application No. 61/405,488, filed on Oct. 21, 2010.
(60) Provisional application No. 61/405,480, filed on Oct. 21, 2010.
(60) Provisional application No. 61/405,488, filed on Oct. 21, 2010.
(60) Provisional application No. 61/324,533, filed on Apr. 15, 2010.
(60) Provisional application No. 61/324,533, filed on Apr. 15, 2010.
(60) Provisional application No. 60/329,281, filed on Oct. 16, 2001.
(60) Provisional application No. 60/581,766, filed on Jun. 23, 2004.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/569,942, filed on Dec. 13, 2011.
(60) Provisional application No. 61/569,949, filed on Dec. 13, 2011.
(60) Provisional application No. 61/705,265, filed on Sep. 25, 2012.
(60) Provisional application No. 61/529,680, filed on Aug. 31, 2011.

(51) Int. Cl. G06Q 50/14; G06Q 30/06

(52) U.S. Cl. CPC G06Q 50/14; G06Q 30/0629
USPC 705/26.64; 705/320

(57) ABSTRACT

A method for managing travel, comprising: performing processing associated with accepting information related to options to satisfy a request for a travel service; and performing processing associated with determining how to display the options to the user so that corresponding travel information is listed side by side.

### CROSS-REFERENCE TO RELATED APPLICATIONS

This application claims the benefit of U.S. Provisional Application No. 61/799,984, filed Mar. 15, 2013 and 61/799,771, filed Mar. 15, 2013. This application is also a continuation-in-part of U.S. patent application Ser. No. 14/188,414, filed Feb. 24, 2014, which is a continuation of U.S. patent application Ser. No. 13/602,589 filed Sep. 4, 2012, which claims the benefit of U.S. Provisional Application Nos. 61/569,942, filed Dec. 13, 2011, and 61/569,949, filed Dec. 13, 2011. U.S. patent application Ser. No. 13/602,589 is also a Continuation-in-Part of U.S. patent application Ser. No. 13/593,108, filed Aug. 23, 2012, which claims the benefit of U.S. Provisional Application No. 61/529,680, filed Aug. 31, 2011. U.S. patent application Ser. No. 13/602,589 is also a Continuation-in-Part of U.S. patent application Ser. No. 13/277,923, filed Oct. 20, 2011 (now U.S. Pat. No. 8,620,750 issued Dec. 31, 2013), which claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 13/277,916, filed Oct. 20, 2011, which claims the benefit of U.S. Provisional Application Nos. 61/405,480, filed Oct. 21, 2010, and 61/405,488, filed Oct. 21, 2010. U.S. patent application Ser. No. 13/602,589 is also a Continuation-in-Part of U.S. patent application Ser. No. 12/901,947, filed Oct. 11, 2010, which claims the benefit of U.S. Provisional Application No. 61/324,533, filed Apr. 15, 2010. U.S. patent application Ser. No. 13/602,589 is also a Continuation-in-Part of U.S. patent application Ser. No. 12/773,282, filed May 4, 2010, which claims the benefit of U.S. Provisional Application No. 61/324,533, filed Apr. 15, 2010. U.S. patent application Ser. No. 13/602,589 is also a Continuation-in-Part of U.S. patent application Ser. No. 11/763,562, filed Jun. 15, 2007, which is a Continuation of U.S. patent application Ser. No. 10/270,672, filed Oct. 16, 2002 (now abandoned), which claims the benefit of U.S. Provisional Application No. 60/329,281, filed Oct. 16, 2001. U.S. patent application Ser. No. 13/602,589 is also a Continuation-in-Part of U.S. patent application Ser. No. 13/396,255, filed Feb. 14, 2012, which is a Continuation of U.S. patent application Ser. No. 12/755,127, filed Apr. 6, 2010 (now U.S. Pat. No. 8,140,361 issued Mar. 20, 2012), which is a Continuation of U.S. patent application Ser. No. 10/373,096, filed Feb. 26, 2003 (now U.S. Pat. No. 7,720,702 issued May 18, 2010). U.S. patent application Ser. No. 13/602,589 is also a Continuation-in-Part of U.S. patent application Ser. No. 13/117,303, filed May 27, 2011, which is a Continuation of U.S. patent application Ser. No. 11/159,398, filed Jun. 23, 2005 (now U.S. Pat. No. 7,974,892 issued Jul. 5, 2011), which claims the benefit of U.S. Provisional Application No. 60/581,766, filed Jun. 23, 2004. This application is also a continuation-in-part of U.S. patent application Ser. No. 14/036,320 filed Sep. 25, 2013, which claims priority to U.S. Provisional Application No. 61/705,265, filed Sep. 25, 2012. U.S. patent application Ser. No. 14/036,320 is also a Continuation-in-Part of U.S. patent application Ser. No. 13/830,319, filed Mar. 14, 2013, which, in turn, is a Continuation of U.S. patent application Ser. No. 13/712,614, filed Dec. 12, 2012, which claims the benefit of U.S. Provisional Application Nos. 61/569,942, filed Dec. 13, 2011, 61/569,949, filed Dec. 13, 2011, and 61/705,265, filed Sep. 25, 2012. U.S. patent application Ser. No. 14/036,320 is also a Continuation-in-Part of U.S. patent application Ser. No. 13/830,410, filed Mar. 14, 2013, which is a Continuation of U.S. patent application Ser. No. 13/712,629, filed Dec. 12, 2012, which claims the benefit of U.S. Provisional Application Nos. 61/569,942, filed Dec. 13, 2011, 61/569,949, filed Dec. 13, 2011, and 61/705,265, filed Sep. 25, 2012. U.S. patent application Ser. No. 13/712,629 is also a Continuation-in-Part of U.S. patent application Ser. No. 13/606,494, filed Sep. 7, 2012. U.S. patent application Ser. No. 13/712,629 is also a Continuation-in-Part of U.S. patent application Ser. No. 13/602,589 , filed Sep. 4, 2012. This application is a continuation in part of U.S. patent application Ser. No. 13/842,913 filed Mar. 15, 2013, which is a continuation in part of U.S. patent application Ser. No. 13/593,108, filed Aug. 23, 2012 which claims the benefit of U.S. Provisional Application No. 61/529,680, filed Aug. 31, 2011. U.S. patent application Ser. No. 13/842,913 is also a continuation in part of U.S. patent application Ser. No. 13/396,255 filed Feb. 14, 2012. This application is a continuation in part of U.S. patent application Ser. No. 14/060,960 filed Oct. 23, 2013, which is a continuation of U.S. Ser. No. 13/277,923 filed Oct. 20, 2011 (now U.S. Pat. No. 8,620,750 issued Dec. 31, 2013). All of the foregoing are incorporated by reference in their entireties for all purposes.

This application is also related to U.S. patent application Ser. No. 11/774,489, filed Jul. 6, 2007 (now abandoned), which is incorporated by reference in its entirety for all purposes.

### BRIEF DESCRIPTION OF THE DRAWINGS

FIG. 1 illustrates a system for alternative trip comparison and/or a system for queue-based interaction, according to an embodiment.

FIG. 2 illustrates a method for alternative trip comparison, according to an embodiment.

FIGS. 3 and 4, show how a user may create a travel request.

FIG. 5 shows how data for the separate proposals may be presented to the user in column form.

FIG. 6 illustrates a workflow process for how the compare and display modules may utilize the proposal information found by the TMC agent and determine how to display this information to the user.

FIG. 7 illustrates a method for queue-based interactions, according to an embodiment.

### DETAILED DESCRIPTION

In some areas, a travel management company (TMC) system may be integrated with a pre-trip approval system, which may referred to as a travel and expense management system. Data may be exchanged between the two solutions so that the TMC may receive a structured trip request (TR), and the user (e.g., traveler, traveler's assistant who completes booking) may receive comprehensive trip options (e.g., air travel, train travel, rental car, hotel room, visa requests, loyalty subscriptions, insurance, taxi or car service, etc.). Such integration may offer various business benefits. The TMC may obtain additional information (e.g., allocations regarding which project, cost center, company department, clients, etc. will be responsible for paying for the TR expenses). The TMC may utilize information from the travel and expense management to determine how to optimize the traveler's experience at the least expensive cost (e.g., using loyalty programs, fee arrangements with certain vendors, etc.). The user may obtain comprehensive information in his TR (e.g., for approval, reporting, travel policy, pricing information)). For example, if a user has a TR that includes an upgrade to first class, this information may be useful because it may require a different approval workflow. This information is helpful to, for example, an employer so that the employer may be able to force the company policies to be obeyed.

FIG. 1 illustrates a system 100 for alternative trip comparison, according to an embodiment. FIG. 1 comprises a travel and expense management system 103 which may communicate with a TMC 108 through a network 104, which may comprise the Internet or an intranet. The communication may be done using, for example, RESTful WebService technology (e.g., described in https://developer.concur.com/what-can-i-do-concur-connect, wheich is herein incorporated by reference), Axis Servelet technology, Comma Separation Values (CSV) technology, File Transfer Protocol (FTP) technology, or any other communication technology, or any combination thereof. Although this specification describe information being accessed by a TMC, in some embodiments, the TMC may pull information from the travel and expense management system, and in other embodiments, the travel and expense management system may push information to the TMC. In still other embodiments, both may occur, or the information exchanged between the two systems may be accessed using any technology available.

The travel and expense management system may comprise: a pre-trip approval module 105, a TMC coordination module 110, a compare and display module 115, a location database 120, a policy database 125, or any combination thereof. The travel and expense management system may also comprise any modules or perform any functions described in the applications incorporated by reference. The pre-trip approval module may communicate with the policy database to determine which workflow process to follow to obtain an approval for a certain item. The policy database may store the policies applicable to certain companies. The TMC coordination module may share any relevant information about TRs with the travel and expense management system. The compare and display module may communicate with the location database to determine how to display the options to the user.

FIG. 6 illustrates a workflow process for how the compare and display modules may utilize the proposal information found by the TMC agent and determine how to display this information to the user. In 605, all possible associations (e.g., to, from, data, class, price) may be created for each service request and, if appropriate, each segment of each service request from the proposal. In 610, metadata may be generated for each association so that corresponding information may be easily found. This may comprise: segment type matching, the distance between two points (using the location database), the date and time between dates, etc. The associations may then be sorted by metadata to order the list by relevance. In 615, the most relevant associations are kept. In 620, the display may be generated according to the segment type (with, for example, the most important segment on the top) and by natural order if needed (e.g., in a multi-leg segment) starting with the request information and then the proposals, so that the proposal information is places nearby (e.g., on the side of), the request information. In one embodiment, the policy database may be accessed and any information which is found to not comply with a company's policy may be highlighted for the user, as also shown in FIG. 5.

FIG. 2 illustrates a method for alternative trip comparison, according to an embodiment. In 1, as shown in FIGS. 3 and 4, a user may create a travel request (TR) with the needed travel needs (e.g., flight, car, train, etc. segments, hotel room, rental car) (e.g., using a travel and expense management application) and may submit it to a travel manager company (TMC) system (e.g., using HTML email, as an XML attachment, as an automated XML attachment if the TMC is set up to receive this data, etc.). The travel service may be flight segments, train segments, car rental, hotel, etc. The TMC agent may access the TR details (e.g., automatically If XML, manually if email) and determine what proposals (e.g., different flight options, difference hotel options) are available to the user. In 2, the TMC may post the proposals to the travel expense and management system and import the proposals into the TR. The posting of the proposals may be displayed according to the process described in FIG. 6, in one embodiment. The user then chooses a proposal, and if necessary, sends it for approval. The TR is then cancelled or approved. In 3, the TMC may access details regarding the booked, approved and cancelled TRs and determine what actions are necessary at that point. For example, If the trip option that was selected by the user has been approved, but is no longer available, the process of selecting a predetermined amount of alternative options (e.g., up to 2 or 3) may be repeated so that the user may choose another option based on what is currently available. The TMC agent will also have the information he needs to update the TR if necessary. In 4, in case of approval, the issued ticket details may be sent in the TR to the travel and expense management system. Thus, if there is an update (e.g., cancellation, change) the TR may be changed accordingly.

Agency proposals may be parsed by the travel and expense management system (e.g., using optical character recognition (OCR) technology to pull the data) and imported into the TR. The data may comprise geolocation information on the codes for the corresponding locations (e.g., airport codes, train station code), and, using location data to compute the distance to determine which locations correspond to which services request in the TR, compare that with the city (e.g., not airport code, train station code, etc.) provided by the customer. The travel and expense management system may then determine the travel legs by determining a location (.e.g., an airport with a certain code) must be near the city provided by the user. The system may also contact the expense database and the authorization request product in the expense database to access information from the user's initial TR and compare those points against the TMC proposals.

As shown in FIG. 5, data for the separate proposals may be presented to the user in column form. The travel and expense management system may tell if a proposal element is not in compliance (e.g., policy compliance) with the users request by highlighting that field. For example, if the user identifies they want a hotel under $200 a night, and the proposal is for $210 a night, that will show up highlighted or differentiated in some way (e.g., as bold or a different color).

If a requested element is the same for all the proposals, the system may illustrate this by presenting the rows for all the proposals merged into one cell. Once the proposals are available in the TR, the user may be notified. The user may review, compare and select his preferred proposal. It should be noted that the TR may be updated (e.g., add/update/cancel segments), so the above steps may be get repeated. The TR may be routed in the approval workflow until it is cancelled or approved. The TMC may access the approved TRs (e.g., orders) and/or cancelled TRs, including the segment details and other information in the TR. The TMC agent may respectively issue or cancel the corresponding tickets. The TMC may optionally post the booked trip, as a confirmation, in its “tickets issued” state.

FIG. 1 also illustrates a system for queue-based interactions. In FIG. 1, the travel and expense management system 103 may also comprise a queue module 150, which may access a TR directly from a TMS and/or a Global Distribution System (GDS).

FIG. 7 illustrates a method for queue-based interactions. In 701, the user may create a travel request (TR) with the needed information for a trip (e.g., flight, car rental, hotel room). In some embodiments, the user may submit the TR to the TMC system, which may be integrated with the travel and expense management system so that the TR is sent to the TMC automatically (e.g., no need to email, etc.).

In 702, the TMC agent may access the TRs pending proposals. A screen on the TMC system may show a TMC agent all the pending requests. The TMC may then directly manage the TR. The TMC agent may update the information and submit it to the GDS for booking The TMC agent may modify a field (e.g., the Request ID) to show the information has been sent to the travel and expense management system and/or to a GDS.

In 703, the travel and expense management system may automatically access the TMC booking directly and/or from the GDS. This process may save time by eliminating a need for the TMC to return the information to the travel and expense management system. In addition, if the information is only sent to the GDS, the TMC agent does not need to do any additional work other than what they already do by sending the information to the GDS. The travel and expense management system may reconcile the booking information from the GDS with the original requested information from the user using the request information. By automatically pulling the information from the GDS and reconciling it with the original request, the travel and expense management system may avoid, for example, having anyone manually enter the information, speeding up the process and avoiding errors. The travel and expense management system may then automatically notify the user the booking has been placed, allowing the user to send confirmation. The booking information may then be automatically sent to the user's manager for approval of the expense item prior to booking This may happen if there is a rule set up indicating that a particular user's approvals should be automatically sent to the manager(s) under certain conditions (e.g., under a certain amount). If this rule is set up, information from the policy database may be used to determine whether or not a request meets all the criteria for approval, and if so, the request will be sent directly to the manager for approval.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for managing travel, comprising:
performing processing associated with accepting information related to options to satisfy a request for a travel service; and
performing processing associated with determining how to display the options to the user so that corresponding travel information is listed side by side.

2. The method of claim 1, wherein in out-of-policy options are highlighted.

3. The method of claim 1, wherein any parts of any option that does not comply with the travel request are highlighted.

4. A method for managing a travel request, comprising:
performing processing associated with receiving information from a TMC regarding a travel request; and
performing processing associated with automatically forwarding the information to a manager for approval.
